(19) United States
(12) Patent Application Publication
(10) Pub. No.: US 2024/0019696 A1
(43) Pub. Date: Jan. 18, 2024

(54) HEAD-UP DISPLAY DEVICE

(71) Applicant: NIPPON SEIKI CO., LTD., Niigata (JP)

(72) Inventors: Takeru Hayashi, Niigata (JP); Hanako Homma, Niigata (JP)

(21) Appl. No.: 18/341,184

(22) Filed: Jun. 26, 2023

(30) Foreign Application Priority Data
Jul. 12, 2022 (JP) 2022-111481

(51) Int. Cl. G02B 27/01

(52) U.S. Cl. CPC G02B 27/0101; G02B 27/0179; G02B 2027/014; G02B 2027/0183

(57) ABSTRACT

To provide a head-up display device that can appropriately guide a driver by giving adequate clarity while reducing annoyance. A head-up display device displays a superimposed image in a display area in front of an own vehicle. A control unit that performs display control of the superimposed image performs information acquisition processing of acquiring travel environment information pertaining to a travel environment of the own vehicle, determination processing of determining whether the travel environment information satisfies a predetermined condition, and animation processing of displaying the superimposed image by animation in which a plurality of still images are successively switched without a light being turned off in a case where the predetermined condition is satisfied. In the animation processing, display switching is performed in which switching is performed from a static display state to a static display state via a dynamic display state, and motion that intermittently changes is expressed.

### TECHNICAL FIELD

The present invention relates to a head-up display device that allows a viewer to view a virtual image.

### BACKGROUND ART

Conventionally, a head-up display device described, for example, in Patent Document 1 is known. In the head-up display device, when a vehicle approaches a navigation target intersection, a numerical value of a remaining distance to the intersection is continuously displayed until the vehicle passes the intersection.

### PRIOR ART DOCUMENT

### Patent Document

Patent Document 1: Japanese Unexamined Patent Application Publication No. 2015-4612

### SUMMARY OF INVENTION

### Technical Problem

However, in the conventional head-up display device, since the numerical value of the remaining distance to the target intersection is continuously displayed for a long period of time while constantly changing, there is a problem that a driver, who is a viewer, feels a strong sense of annoyance.

On the other hand, to avoid the above, a method is also conceived in which a light-on state and a light-off state of a display are alternately repeated, and a display content is changed each time the display blinks. However, such a blinking display may give excessive attractiveness to a driver, and the driver may unnecessarily gaze at the display. In addition, in a case where the driver misses a change in the display content, it is difficult for the driver to intuitively understand that the change is a significant part of a series of display actions.

In view of the above, the present invention has been made taking into account the above problem, and an object of the present invention is to provide a head-up display device that can appropriately guide a driver by giving adequate clarity while reducing annoyance.

### Solution to Problem

The present invention relates to a head-up display device 10 that displays a superimposed image V in such a way as to be viewed by a viewer 5, as a virtual image V overlapping a scenery in front of an own vehicle 1 in a display area 3 in front of the own vehicle 1. The head-up display device 10 includes a control unit 31 that performs display control of the superimposed image V. The control unit 31 performs information acquisition processing S1 of acquiring travel environment information pertaining to a travel environment of the own vehicle 1, determination processing S2 of determining whether the travel environment information acquired by the information acquisition processing S1 satisfies a predetermined condition, and animation processing S3 of displaying the superimposed image V by animation in which a plurality of still images are successively switched without a light being turned off, in a case where it is determined that the predetermined condition is satisfied by the determination processing S2. In the animation processing S3, display switching is performed in which switching is performed from a static display state of one of the still images to a static display state of a next still image in a sequence via a dynamic display state in which switching is performed through dynamic change from one of the still images to the next still image in the sequence, and motion that intermittently changes is expressed.

### Advantageous Effects of Invention

According to the present invention, since a change in an image is intermittently expressed by switching the image between a static display state and a dynamic display state, a driver can concentrate on driving by reducing annoyance on display, while giving appropriate attractiveness to the driver without giving excessive attractiveness. In addition, since a display state of a still image intervenes in the intermittent change in the image as needed, a change in motion increases, and the driver can easily recognize the motion expressed by the change.

### BRIEF DESCRIPTION OF DRAWINGS

FIG. 1 is an explanatory diagram illustrating how a head-up display device according to one embodiment of the present invention is mounted in a vehicle.

FIG. 2 is a block diagram of a vehicle display system using the head-up display device.

FIG. 3 is a flowchart illustrating processing of a control unit in the head-up display device.

FIG. 4 is a diagram illustrating an amount of change of a display content in a case where display switching is performed only once from a first still image to a last still image, and in a case where display switching is performed plural times.

FIG. 5 is a diagram illustrating a starting point of a static display state and a dynamic display state, and a display switching point in a specific example of navigation.

FIGS. 6A to 6E are diagrams illustrating an example of navigation display in a case of guiding to an exit of an expressway.

FIGS. 7A and 7B are diagrams illustrating a starting point of a static display state and a dynamic display state, and a display switching point in a case of changing the display switching point, which is one of display parameters in the specific example in FIG. 5.

FIG. 8 is a diagram illustrating a starting point of a static display state and a dynamic display state, and a display switching point in a case of reducing the number of the display switching points, which is one of display parameters in the specific example in FIG. 5.

FIG. 9 is a diagram illustrating an example of a case of displaying a travel route after course change in a highlighted manner.

FIG. 10 is a diagram illustrating time of a dynamic display state with respect to a speed of an own vehicle.

### DESCRIPTION OF EMBODIMENTS

A head-up display device (hereinafter, referred to as a HUD device) according to one embodiment of the present invention is described with reference to the drawings.

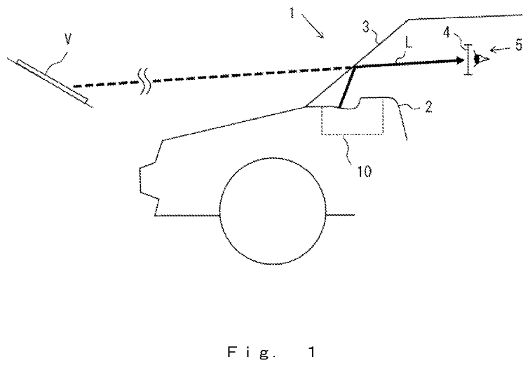

FIG. 1 is an explanatory diagram illustrating how a HUD device according to the present embodiment is mounted in a vehicle. A HUD device 10 is installed inside a dashboard 2 of a vehicle (own vehicle) 1, and emits display light L toward a combiner-treated windshield (display area) 3 as a display area. The display light L reflected on the windshield 3 is directed toward a driver (viewer) 5. The driver 5 can view an image represented by the display light L, as a virtual image (superimposed image) V in front of the windshield 3 by placing his/her viewpoint in an eye box 4. In other words, the HUD device 10 displays the virtual image V at a forward position of the windshield 3. This allows the driver 5 to observe the virtual image V by superimposing the virtual image V on a forward scenery.

Note that, information to be notified to the driver 5 may include, for example, information relating to the vehicle 1, and information (hereinafter, referred to as vehicle information) on the outside of the vehicle 1 associated with an operation of the vehicle 1. The information may also be integrated broadcast information including information other than the vehicle information.

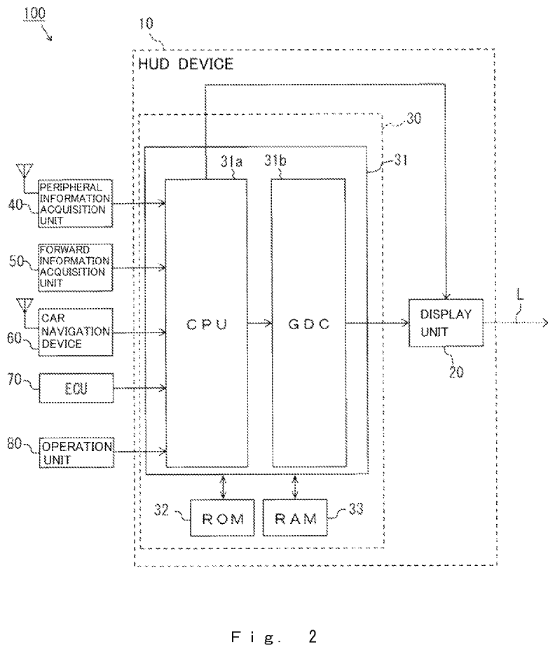

FIG. 2 is a block diagram of a vehicle display system using the HUD device according to the present embodiment. A vehicle display system 100 illustrated in FIG. 2 is a system configured in the vehicle 1 by using the HUD device 10 in FIG. 1; and includes the HUD device 10 described above, a peripheral information acquisition unit 40 that acquires information in the periphery (outside) of the vehicle 1 through communication, a forward information acquisition unit 50 constituted of various sensors and the like for acquiring information in front of the vehicle 1, a car navigation device (hereinafter, referred to as a car navigation device) 60 including a GPS controller and the like that compute a position of the vehicle 1, based on a GPS signal, an electronic control unit (ECU) 70 that controls each part of the vehicle 1, and an operation unit 80 that accepts various operations by the driver 5.

The HUD device 10 includes a display unit 20, a reflective unit (not illustrated in FIG. 2), and a control device 30. The display unit 20 displays a superimposed image to be viewed by the driver 5, as the virtual image V, under the control of the control device 30. The display unit 20 includes, for example, a thin film transistor (TFT) type liquid crystal display (LCD), a backlight that illuminates the LCD from behind, and the like. The backlight is constituted of, for example, a light emitting diode (LED). The display unit 20 generates the display light L by causing the LCD illuminated by the backlight under the control of control device 30 to display an image. The generated display light L is reflected on the reflective unit, and then emitted toward the windshield 3.

Note that, in the present embodiment, causing the display unit to display an image to be viewed by the driver 5, as the virtual image V, is referred to as “displaying a superimposed image” as described above, and causing the control device 30 to be described later to perform display control of the display unit 20 is referred to as “performing display control of a superimposed image”. Further, the display unit 20 is not limited to the one using an LCD, as long as the display unit 20 can display a superimposed image, and the display unit 20 may be the one using a display device, such as organic light emitting diodes (OLEDs), a digital micro mirror device (DMD), liquid crystal on silicon (LCOS), and the like.

The reflective unit is constituted of two mirrors, for example, a folding mirror and a concave mirror. The folding mirror folds back the display light L emitted from the display unit 20, and directs the display light L toward the concave mirror. The concave mirror reflects the display light L from the folding mirror toward the windshield 3 while magnifying the display light L. This allows the virtual image V to be viewed by the driver 5 to be an enlarged image displayed on the display unit 20. Note that, at this occasion, it is desirable that an upper end of the virtual image V is inclined forward or in parallel to a front road surface. In other words, it is desirable that the virtual image V is displayed as a first image to be viewed along the front road surface of the vehicle 1, or a second image to be viewed in such a way that the image rises toward the driver 5 side than the first image. This reduces annoyance to the driver 5 and wall-like feeling as compared with an elevational HUD device, even in a case where the virtual image V is constantly displayed on the windshield 3, thereby adequately presenting necessary information without disturbing concentration of the driver 5.

The control device 30 is constituted of a microcomputer that controls an overall operation of the HUD device 10, and includes a control unit 31 that performs drive control of the display unit 20, a ROM 32 in which a program and various pieces of data are stored, and a RAM 33 that temporarily stores a computation result and the like of a CPU 31a. The control device 30 also includes, as an unillustrated configuration, a drive circuit, input/output circuits for communicating with various systems in the vehicle 1, and the like. Note that, the configuration of the control device 30 and the control unit 31 is described merely as an example, and is not limited thereto.

The control unit 31 includes the CPU 31a that executes an operation program stored in the ROM 32, and a graphics display controller (GDC) 31b that performs image processing in cooperation with the CPU 31a. The control unit 31 drives and controls the backlight of the display unit 20 by the CPU 31a, and drives and controls the LCD of the display unit 20 by the GDC 31b that operates in cooperation with the CPU 31a. Note that, the GDC 31b is constituted of, for example, a graphics processing unit (GPU), a field-programmable gate array (FPGA), an application specific integrated circuit (ASIC), and the like. In particular, the ROM 32 stores an operation program for performing display control to be described later.

The CPU 31a performs display control of a superimposed image, based on various pieces of image data stored in the ROM 32 in cooperation with the GDC 31b. The GDC 31b determines a control content of a display operation of the display unit 20, based on a display control command from the CPU 31a. The GDC 31b reads, from the ROM 32, image part data necessary to compose one screen to be displayed on the display unit 20, and transfers the data to the RAM 33.

The GDC 31b generates picture data for one screen, based on image part data, and various pieces of image data received from outside of the HUD device 10 through communication with use of the RAM 33. Then, the GDC 31b completes the picture data for one screen in the RAM 33, and transfers the data to the display unit 20 in synchronism with an update timing of an image. This causes the display unit 20 to display a superimposed image to be viewed by the driver 5, as the virtual image V. In addition, a layer is allocated in advance to each image constituting an image to be viewed as the virtual image V, and the control unit 31 is able to control display of each image individually. More detailed description on display control according to the present embodiment is made later.

Further, the CPU 31a communicates with each of the peripheral information acquisition unit 40, the forward information acquisition unit 50, the car navigation device 60, the ECU 70, and the operation unit 80. For example, communication methods such as a controller area network (CAN), Ethernet, media oriented systems transport (MOST), low voltage differential signaling (LVDS), and the like are applicable as the communication.

The peripheral information acquisition unit 40 is constituted of various modules that enable communication between the vehicle 1 and a wireless network (V2N: Vehicle To cellular Network), communication between the vehicle 1 and another vehicle (V2V: Vehicle To Vehicle), communication between the vehicle 1 and a pedestrian (V2P: Vehicle To Pedestrian), and communication between the vehicle 1 and a roadside infrastructure (V2I: Vehicle To Roadside Infrastructure). In other words, the peripheral information acquisition unit 40 enables communication by V2X (Vehicle To Everything) between the vehicle 1 and outside of the vehicle 1.

For example, the peripheral information acquisition unit 40 includes a communication module capable of directly accessing to a wide area Network (WAN), a communication module for communicating with an external device (such as a mobile router) accessible to the WAN, an access point and the like of a public wireless local area network (LAN), and the like, and performs Internet communication. The peripheral information acquisition unit 40 also includes a GPS controller that computes a position of the vehicle 1, based on a global positioning system (GPS) signal received from an artificial satellite and the like. These configurations enable communication by V2N.

Further, the peripheral information acquisition unit 40 includes a wireless communication module compliant with predetermined wireless communication standards, and performs communication by V2V or V2P. Furthermore, the peripheral information acquisition unit 40 includes a communication device that communicates wirelessly with a roadside infrastructure, and acquires object information and traffic information, for example, from a base station of driving safety support systems (DSSS) via a roadside wireless device installed as an infrastructure. This enables communication by V2I.

In the present embodiment, the peripheral information acquisition unit 40 acquires, by V2I, object information indicating a position, a size, an attribute and the like of various objects such as a vehicle being present outside the vehicle 1, which is an own vehicle (hereinafter, simply referred to as the “own vehicle 1”), a traffic signal, and a pedestrian, and supplies the object information to the control unit 31. Note that, the object information is not limited to V2I, but may be acquired by any communication among V2X. Also, the peripheral information acquisition unit 40 acquires traffic information including a position and a shape of a surrounding road of the own vehicle 1 by V2I, and supplies the traffic information to the control unit 31. Also, the control unit 31 computes a position of the own vehicle 1, based on information from the GPS controller in the peripheral information acquisition unit 40.

The forward information acquisition unit 50 is constituted of, for example, a stereo camera that captures an image of a scenery in front of the own vehicle 1, a distance measurement sensor such as a laser imaging detection and ranging (LIDAR) that measures a distance from the own vehicle 1 to an object located in front of the own vehicle 1, a sonar, an ultrasonic sensor, a millimeter wave radar that detect an object located in front of the own vehicle 1, and the like. In the present embodiment, the forward information acquisition unit 50 transmits, to the CPU 31a, forward image data indicating a forward scenery image captured by the stereo camera, data indicating a distance to an object measured by the distance measurement sensor, and other detection data.

The car navigation device 60 includes a GPS controller that computes a position of the own vehicle 1, based on a GPS signal received from an artificial satellite and the like, and includes a storage unit that stores map data. The car navigation device 60 reads, from the storage unit, map data in the vicinity of a current position, based on position information from the GPS controller, and determines a guide route to a destination set by the user. Further, the car navigation device 60 outputs, to the control unit 31, information relating to a current position of the own vehicle 1, and the determined guide route. The car navigation device 60 also outputs, to the control unit 31, information indicating a name and a type of a facility in front of the own vehicle 1, a distance between the facility and the own vehicle 1, and the like by referring to the map data. In the map data, various pieces of information such as road shape information (such as a lane, a road width, the number of lanes, an intersection, a curve, and a branch road), regulatory information relating to road signs such as a speed limit, and information about each lane in a case where a plurality of lanes are present are associated with position data. The car navigation device 60 outputs, to the CPU 31a, these various pieces of information, as route guidance information.

Note that, the car navigation device 60 is not limited to the one mounted in the own vehicle 1, but may be achieved by a mobile terminal (such as a smartphone and a tablet PC) that communicates with the control unit 31 by a wired or wireless means, and includes a car navigation function.

The ECU 70 controls each part of the own vehicle 1, and transmits, to the CPU 31a, for example, vehicle speed information indicating a current vehicle speed of the own vehicle 1. Note that, the CPU 31a may acquire vehicle speed information from a vehicle speed sensor. The ECU 70 also transmits, to the CPU 31a, a measurement amount such as an engine speed, warning information (such as fuel lowering, and an engine oil pressure anomaly) on the own vehicle 1 itself, and other piece of vehicle information. The CPU 31a can display, on the display unit 20, vehicle information indicating a vehicle speed, an engine speed, various warnings, and the like via the GDC 31b, based on information acquired from the ECU 70.

The operation unit 80 accepts various operations by the driver 5, and supplies a signal indicating an accepted operation content to the CPU 31a. For example, the operation unit 80 accepts an operation of switching a display mode of the virtual image V by the driver 5, and the like.

In the following, display control according to the present embodiment is described in detail. FIG. 3 is a flowchart illustrating processing of the control unit 31 in the HUD device according to the present embodiment. In FIG. 3, the control unit 31 performs processing of acquiring travel environment information pertaining to a travel environment of the own vehicle 1, such as a vehicle speed of the own vehicle 1, presence or absence of another peripheral vehicle such as a preceding vehicle, and a travel position of the own vehicle through the peripheral information acquisition unit 40, the forward information acquisition unit 50, the car navigation device 60, the ECU 70, the operation unit 80, and the like (S1). The processing S1 is an example of information acquisition processing. It is determined whether travel environment information acquired by the information acquisition processing S1 satisfies a predetermined condition such as a case where a distance from a current travel position of the own vehicle to a position (e.g., such as an intersection, a junction, a merge position, and an exit of an expressway or a highway) where course change is required becomes equal to or less than a predetermined distance, or a case where a distance to a location where the speed limit is switched becomes equal to or less than a predetermined distance (S2). The processing S2 is an example of determination processing. In a case where it is determined that the predetermined condition described above is satisfied as a result of the determination processing S2, a superimposed image is displayed by animation in which a plurality of still images are successively switched without the light being turned off (S3). The processing S3 is an example of animation processing.

The animation processing S3 is described in detail. In the animation processing S3, display switching is performed in which an image is switched from a static display state of one still image to a static display state of a next still image in a sequence via a dynamic display state (e.g., a dynamic display state such that a size or a length of an image included in a still image changes, a position of the image changes, the image is divided, the image is thinned out, a part of the image is hidden, another image interrupts or appears, a travel route is highlighted in a specific display mode (such as coloring or blinking) in which switching is performed through dynamic change from one of the still images to the next still image in the sequence, and motion that intermittently changes is expressed.

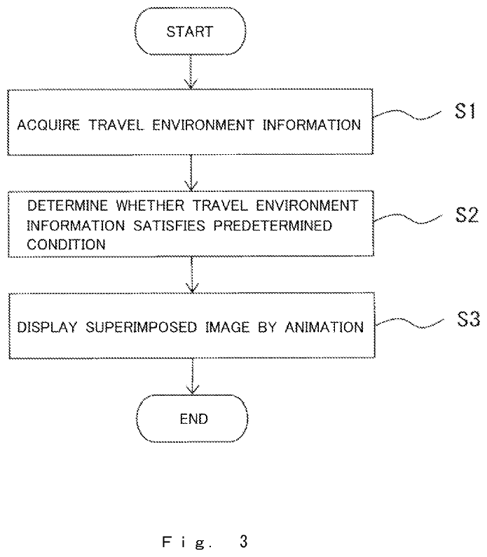

At this occasion, it is desirable to perform the above display switching at least twice or more from display of a first still image to display of a last still image. FIG. 4 is a graph indicating an amount of change of a display content in a case where display switching constituted of a dynamic display state for 50 seconds from a first still image to a last still image is performed only once, and in a case where multiple display switching constituted of a static display state of four times for about 30 seconds in total, and a dynamic display state of four times for about 20 seconds in total, within 50 seconds, is performed. From the graph in FIG. 4, the amount of change (change rate) in display switching per time becomes large, since a period for a static display state is present, in a case where multiple display switching is performed as compared with a case where display switching is performed only once.

By performing multiple display switching as described above, the driver 5 is more likely to be attracted to a large change in a display content, which makes it easy for the driver 5 to view the display change. In addition, since presence of a period for a static display state reduces a likelihood that the driver 5 is attracted to a superimposed image more than necessary, it is possible to reduce annoyance on display. Furthermore, since the superimposed image is constantly displayed without the light being turned off, a series of animation display can be recognized intuitively.

Display control as described above is particularly advantageous in a case where the driver 5 is required to be notified in advance, such a s a case where a course change starting point is approaching, or a case where a section where the speed limit is to be changed is approaching. Hereinafter, a case of navigating a travel route of the own vehicle 1 when the own vehicle 1 traveling on an expressway is approaching an exit is described by means of a specific example. FIG. 5 is a diagram illustrating a starting point of a static display state and a dynamic display state, and a display switching point in a specific example of navigation. In FIG. 5, for example, a point at which a main lane and a deceleration lane intersect near an exit of an expressway is set as a course change starting point 103. A point away from the course change starting point 103 by a predetermined distance (e.g., about 300 m) is set as a display starting point 101. Note that, setting the display starting point 101 near a signboard indicating an exit guidance, for example, can easily connect a meaning between information on the signboard and a superimposed image to be displayed on the HUD device 10, which helps the driver 5 to understand in a short time. Then, a plurality of the display switching points 102, which are points where display switching is performed, are set between the display starting point 101 and the course change starting point 103. The interval between the plurality of the display switching points 102 may be equally spaced or may vary according to a shape of a road and other factors.

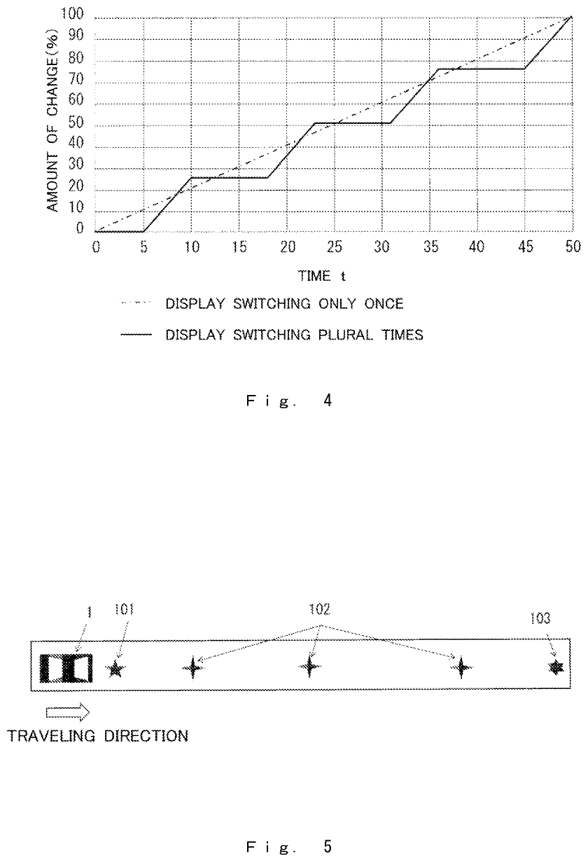

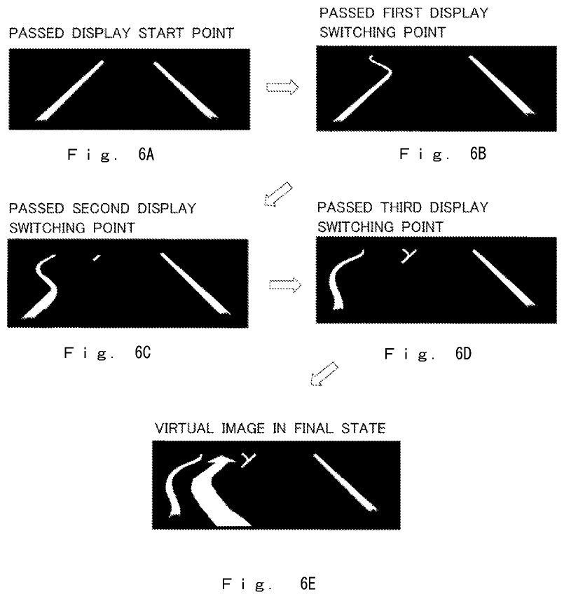

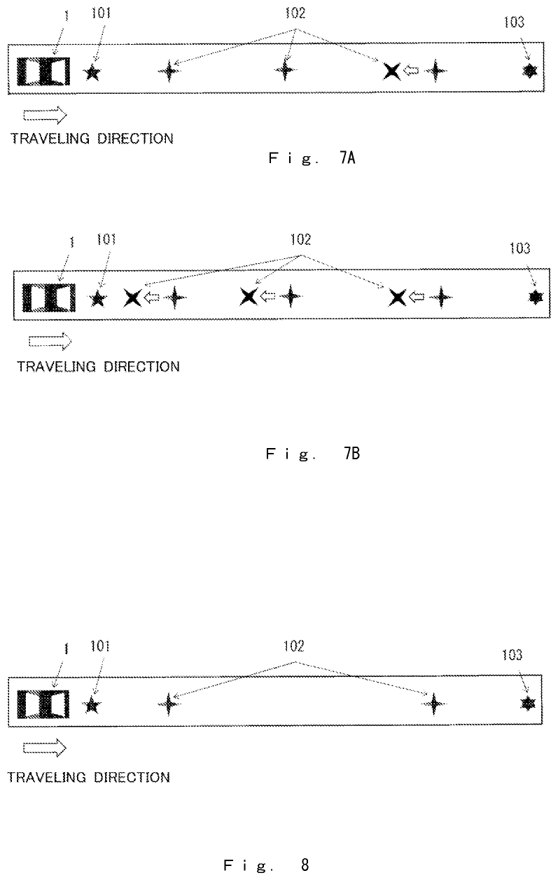

FIGS. 6A to 6E are diagrams illustrating an example of navigation display in a case of guiding to an exit of an expressway. In a case where the control unit 31 acquires, as travel environment information, a travel position of the own vehicle 1 in the information acquisition processing S1, and determines that the own vehicle 1 has passed the display starting point 101, which is a point at a predetermined distance to a target point for navigation (e.g., the course change starting point 103, which is an exit of an expressway), the control unit 31 performs display that imitates a lane boundary line of an actual scenery as illustrated in FIG. 6A. Until the own vehicle 1 passes the first display switching point 102, the still image in FIG. 6A is displayed as a superimposed image without the light being turned off. This state is a static display state.

In a case where it is determined that the own vehicle 1 has gradually moved forward and passed the first display switching point 102, animation display that can be viewed in such a way that the own vehicle 1 is moving forward (specifically, moving image display in which a plurality of frames are continuously switched at a predetermined interval) is performed by dynamically changing a length or a shape of the lane boundary line in such a way that the image is changed from the still image in FIG. 6A to the still image in FIG. 6B. This state is a dynamic display state. Then, a static display state is achieved in which the still image in FIG. 6B is displayed again as a superimposed image without the light being turned off.

Likewise, in a case where it is determined that the own vehicle 1 has gradually moved forward and passed the second and third display switching points 102, animation display is performed by dynamically changing the length or the shape of the lane boundary line in such a way that the image is changed from the still image in FIG. 6B to the still image in FIG. 6C, and from the still image in FIG. 6C to the still image in FIG. 6D. At this occasion, in the static display state, the image is constantly displayed as a superimposed image without the light being turned off in FIG. 6C and FIG. 6D. In the example in FIGS. 6A to 6E, depicting a lane boundary line of a deceleration lane allows the driver 5 to view in such a way that the own vehicle 1 is moving forward and approaching an exit of an expressway.

Note that, in a case where a dynamic display state is displayed at each display switching point 102, a rate of the change may be constant, or may be changed stepwise according to a distance to the course change starting point 103. In particular, increasing a rate of change of a dynamic display state, as the number of passing display switching point 102 increases enables to increase attractiveness to the driver 5, and securely allows the driver 5 to recognize that the course change starting point 103 is steadily approaching.

In addition, the shape of an actual deceleration lane on an expressway varies from place to place. When the shape of an actual deceleration lane, and a shape of a deceleration lane to be displayed as a superimposed image differ significantly, a relevance between the deceleration lane that is viewed by the driver 5, as the actual deceleration lane, and the deceleration lane that is viewed as the superimposed image may become less, which makes it difficult for the driver 5 to recognize the deceleration lane. To prevent such a situation, for example, display modes of a plurality of patterns of deceleration lanes may be stored in advance in the ROM 32 or the like, an actual shape of a deceleration lane may be recognized from map information, and the deceleration lane of a pattern most similar to the shape of the recognized deceleration lane may be displayed on the display unit 20. Also, the shape of the deceleration lane may be acquired from map information, and a display image of a deceleration lane having the same shape as the acquired shape may be generated and displayed.

In a case where the vehicle passes the display switching point 102, which is a point nearest to the course change starting point 103, specifically, the display switching point 102 immediately before switching is performed to the last still image in the sequence, control promotion display for promoting operation control to be performed in a case where the vehicle reaches the course change starting point 103 is newly added and displayed in the dynamic display state. Specifically, an arrow as illustrated in FIG. 6E is displayed, and animation display is performed in which a tip of the arrow appears from below a superimposed screen, and the arrow itself extends as the vehicle gradually moves in such a way as to enter a deceleration lane.

Note that, in this case, it is desirable to perform animation display at a timing at which a tip of the arrow to be displayed as the virtual image V is displayed in such a way as to enter a deceleration lane on an actual scenery. In this way, it is possible to intuitively convey to the driver 5 that a destination pointed by the arrow is an exit of an expressway where the driver 5 should exit. In addition, an arrow icon as illustrated in FIG. 6E may be displayed on an image that imitates a deceleration lane, or in a case where there is a toll booth near the exit, an image of the toll booth may be displayed.

Furthermore, an amount of change by animation display of control promotion display may be desirably larger than an amount of change of a dynamic display state that has been performed at a previous display switching point 102. In this way, display switching in which an amount of change is large is performed at a position nearest to the course change starting point 103, and the driver 5 can recognize with high probability that the course change starting point 103 is approaching. Even in a case where the driver 5 cannot recognize a dynamic change state by animation display at a previous display switching point 102, it is possible to notify the driver 5 that the course change starting point 103 is approaching in a dynamic change state by animation display at the last display switching point 102.

In addition, in the foregoing, control promotion display is performed at the display switching point 102, which is a position nearest to the course change starting point 103. However, control promotion display may be performed at another display switching point 102. In display switching after control promotion display is performed, for example, road information or the like after the vehicle leaves a toll booth or exits an expressway may be displayed, or a virtual image V displaying that the own vehicle 1 is about to enter a deceleration lane may be displayed.

In this way, in the HUD device 10 according to the present embodiment, in a case where travel environment information acquired by the information acquisition processing S1 satisfies a predetermined condition, the CPU 31a performs the animation processing S3. In the animation processing S3, performing display switching from a static display state of one static image to a static display state of a next still image via a dynamic display state expresses intermittently changing motion. At this occasion, one still image remains to be displayed for a predetermined period of time until a timing at which switching is performed to a next still image arrives. This reduces a likelihood that the driver 5, who is a viewer, may be attracted to the virtual image V of a superimposed image more than necessary, thus reducing annoyance on display and allowing the driver 5 to concentrate on driving. In addition, since the still image is continued to be in a lit state without the light being turned off, excessive attractiveness as in a case where display blinks is not given to the driver 5, and it is easy for the driver 5 to intuitively understand that the image represents a series of display switching. Furthermore, intervening a display state of a still image as needed increases a difference in image content, specifically, an amount of change increases between one still image and a next still image in a sequence for expressing motion, and the driver 5 can more easily recognize motion to be expressed by the change.

In addition, by causing the CPU 31a to execute display switching of controlling a superimposed image from a static display state to a static display state via a dynamic display state at least twice or more, behavior of a change of the superimposed image becomes clear as compared with a case where display switching is performed only once, and appropriate attractiveness can be given to the driver 5. Also, since a static display state is achieved at least once during a time when the image becomes a dynamic display state at least twice, the driver 5 can securely concentrate on driving during the time.

Furthermore, the driver 5 is allowed to statically view a lane boundary line when the own vehicle 1 is approaching a navigation target point (an exit of an expressway in the above example), and thereafter, allowing the driver 5 to view a dynamic change in the length or the shape of the lane boundary line provides effective guidance when guidance necessity to the driver 5 increases.

Furthermore, performing control promotion display at a timing at which some new vehicle control is required in the driver 5 enables to provide clear and effective guidance in such a way that the driver 5 securely performs the vehicle control.

Note that, in the present embodiment, a case has been described in which an exit of an expressway is guided as an example of navigation display, but display control according to the present embodiment can be applied to a case other than the above, for example, a case where information of prompting a course change is displayed near a crossroad, a three-way intersection, a roundabout intersection, or the like.

Further, in display of a superimposed image as described above, a luminance of a part or the entirety of the virtual image V to be displayed may be changed during a time from the display starting point 101 until the course change starting point 103 via the plurality of display switching points 102. Specifically, by changing a luminance value significantly, as the vehicle approaches the course change starting point 103, the superimposed image, which was initially less attractive to the driver 5, gradually becomes more attractive, thereby making it easy for the driver 5 to view a final display state of the superimposed image. At the same time, in order to prevent attractiveness of the superimposed image from increasing more than necessary, it is desirable to set a luminance of the virtual image V in an area on the side close to a line-of-sight area (area in front of the driver 5) toward which the driver 5 is directed for driving to be smaller than that in other areas. In other words, by setting a luminance value of the virtual image V in an area where the driver is likely to view to be relatively small, it becomes possible to suppress attractiveness to the driver 5 more than necessary.

In the following, the HUD device 10 according to another embodiment of the present invention is described.

It is possible to concentrate on driving, while reducing annoyance on display by performing display control of a superimposed image as described above. However, it is difficult for some drivers 5 to sufficiently view a change in the superimposed image in a situation that requires a higher level of concentration on driving, such as a case where high-speed driving is performed or in a case where a preceding vehicle is present. In this case, there is a risk that the driver may miss the change in the superimposed image, and neglect safe driving without noticing the course change starting point 103.

As a first method of handling a situation as described above, for example, a method is conceived in which the CPU 31a of the control unit 31 sets some or all of the display switching points 102, which is one of display parameters, to a position away from the course change starting point 103. This processing of variably setting a display parameter corresponds to an example of first setting processing.

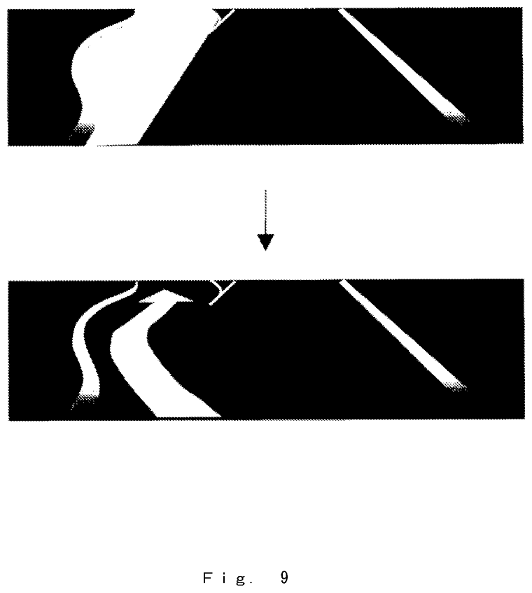

FIGS. 7A and 7B are diagrams illustrating a starting point of a static display state and a dynamic display state, and a display switching point in a case where the display switching point 102, which is one of the display parameters, is changed in the specific example in FIG. 5. FIG. 7A illustrates a case where only the display switching point 102 nearest to the course change starting point 103 is moved away from the course change starting point 103, and FIG. 7B illustrates a case where all the display switching points 102 are moved away from the course change starting point 103. As illustrated in FIGS. 7A and 7B, setting a position of the display switching point 102 to a position away from the course change starting point 103 enables to expedite a timing at which a dynamic display state is started to be displayed, and give the driver 5 an early warning that the course change starting point 103 is approaching and give the driver 5 some time for mental preparation. Thus, an advantageous effect of helping the driver to perform a course change safely can be expected.

Note that, it is optional which one of the plurality of display switching points 102 to be set is moved away from the course change starting point 103. All of the display switching points 102 may be moved away, some of the display switching points 102 may be moved away, or the first setting processing may not be performed if not necessary.

Further, change settings of the display switching point 102 may be derived by computation by the CPU 31a, based on information acquired from the peripheral information acquisition unit 40, the forward information acquisition unit 50, the car navigation device 60, the ECU 70, the operation unit 80, and the like. For example, when the location is a place where an accident occurs frequently, weighted computation is performed in such a way that a distance between the course change starting point 103 and the display switching point 102 becomes as large as possible. In addition to the above, the distance between the course change starting point 103 and each display switching point 102 may be computed based on various parameters such as a road surface condition, a current vehicle speed, a traffic jam condition, a vehicle type, a day of week, a time zone, a season, and a weather.

As a second method, for example, a method is conceived in which the CPU 31a of the control unit 31 reduces the number of the display switching points 102, which is one of the display parameters. This processing of variably setting a display parameter also corresponds to an example of the first setting processing.

FIG. 8 is a diagram illustrating a starting point of a static display state and a dynamic display state, and a display switching point in a case where the number of the display switching points 102, which is one of the display parameters in the specific example in FIG. 5, is reduced. Setting the display switching points 102 as illustrated in FIG. 8 enables to reduce the number of times when the image is shifted to a dynamic display state, as the number of the display switching points 102 is reduced, and consequently, an amount of change of the dynamic display state per time becomes large. In other words, changing a superimposed image largely increases attractiveness of the image, and makes it possible to securely notify the driver 5 of the change in the superimposed image. Note that, it is optional as to which one of the display switching points 102 is to be deleted. However, for example, thinning out the display switching point 102 within a range away from the course change starting point 103 by a predetermined distance is conceived. Further, the first setting processing may not be performed if not necessary.

As illustrated in FIG. 8, display control of a series of superimposed images during a time when the vehicle travels from the display starting point 101 to the course change starting point 103 in a case where the number of the display switching points 102 is reduced is described in detail. In a case of FIG. 8, a state is set in which the second display switching point 102 is thinned out as compared with a case in FIG. 5. In other words, in the settings in FIG. 5, display switching is performed at each display switching point 102, but in the case of settings in FIG. 8, display switching is not performed at the display switching point 102 corresponding to the second point in FIG. 5, and the static display state that has been switched at the display switching point 102 corresponding to the first point in FIG. 5 is retained until the vehicle reaches the position of the display switching point 102 corresponding to the third point in FIG. 5. Then, at a timing at which the vehicle reaches the display switching point 102 corresponding to the third point in FIG. 5, a dynamic display state is displayed in which the image is changed from a static display state after display switching corresponding to the first point in FIG. 5 to a static display state corresponding to the third point in FIG. 5 via a static display state corresponding to the second point in FIG. 5, and finally, the image reaches a static display state after display switching corresponding to the third point in FIG. 5. Thus, the amount of change of the dynamic display state at the display switching point 102 (specifically, the second display switching point 102 in FIG. 8) corresponding to the third point in FIG. 5 becomes large, and the change in the superimposed image is appropriately attractive to the driver 5.

Note that, similarly to a case described in FIG. 7, the change settings of the display switching point 102 may be derived by causing the CPU 31a to compute an appropriate number of display switching points 102 to be set. At this occasion, as described above, the number of the display switching points 102 may be computed based on various parameters such as the number of accidents in the vicinity, a road surface condition, a current vehicle speed, a traffic jam condition, a vehicle type, a day of week, a time zone, a season, and a weather.

As a third method, for example, a method is conceived in which the CPU 31a of the control unit 31 shortens a duration of time of a dynamic display state, which is one of the display parameters. This processing of variably setting a display parameter also corresponds to an example of the first setting processing. In a case of setting the duration of time of a dynamic display state to be short, since a rate of change of the virtual image V becomes large, the driver 5 can be appropriately attracted without missing the change of the virtual image V.

When only a duration of time of a dynamic display state is shortened, the driver 5 may miss a change because the change is too quick. In view of this, combining the above with a case of reducing the number of the display switching points 102 as illustrated in FIG. 8 enables to increase an amount of change of the dynamic display state per time, thereby more appropriately increasing attractiveness.

In this way, performing the first setting processing, and variably setting various display parameters pertaining to a dynamic display state and a static display state such as, for example, a timing at which animation processing (dynamic display state) is started, the number of times of display switching, and a duration of time of a dynamic display state enables to adjust attractiveness to the driver 5, and contribution to safety improvement of a vehicle as necessary, for example, according to a purpose of use or usage, an attribute or personality of the driver 5, and the like.

More specifically, in a case where a distance between the course change starting point 103 and the display switching point 102 is made variable, expediting a start timing of animation processing enables to give the driver 5 mental preparation, and enhance safety. Further, for example, in a case where the number of the display switching points 102 is made variable, reducing the number of the display switching points 102 increases the amount of change of an image content in a dynamic display state, thereby increasing attractiveness to the driver 5. In addition, for example, in a case where a duration of time of a dynamic display state per time is made variable, shortening the duration of time increases a speed of change (rate of change) of an image content in the dynamic display state, thereby also increasing attractiveness to the driver 4.

In addition to the first through third methods described above, for example, it is possible to cause the CPU 31a of the control unit 31 to perform control display of enhancing safety of the driver 5 by variably setting a dynamic switching mode in a dynamic display state. Specifically, for example, before control promotion display is performed, a travel route to follow may be displayed in a highlighted manner by coloring or the like. The processing of setting in such a way as to display a travel route to follow in a highlighted manner corresponds to an example of second setting processing.

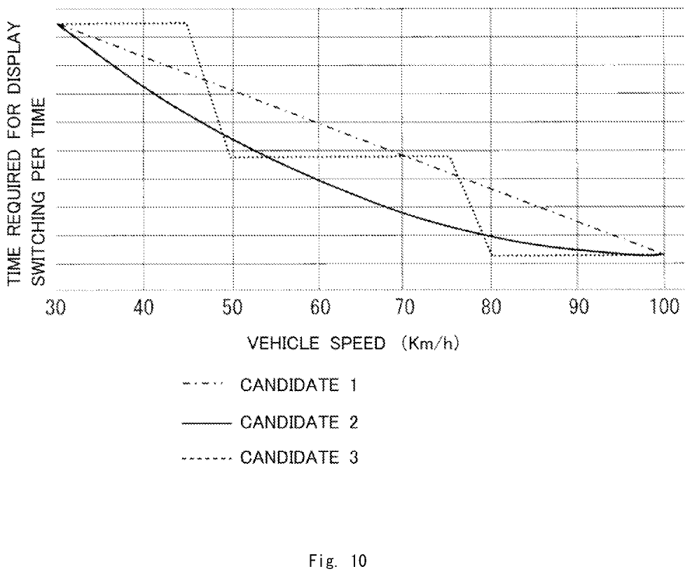

The method of displaying a travel route to follow in a highlighted manner is particularly advantageous in a case where a preceding vehicle is present. When a preceding vehicle is present, it may be difficult to check a shape of the road ahead, and it may not be possible to recognize a position of the course change starting point 103 until just before the course change starting point 103 appears. In such a case, before performing control promotion display as illustrated in FIG. 6E, displaying in advance the travel route to follow in a highlighted manner after the own vehicle 1 has changed the course enables to let the driver 5 know that the course change starting point 103 is approaching, and also encourage the driver to prepare for smoothly performing a course change such as which lane, the driver is needed to enter in advance for changing the course. Note that, as illustrated in FIG. 9, as a method of emphasizing, displaying a travel route in color after course change is conceived. In addition to the above, changing the color of a division line of a travel route after course change is also conceived.

In this way, performing the second setting processing, and variably setting the dynamic switching mode in a dynamic display state, it becomes possible to adjust contribution to safety improvement of a vehicle as necessary according to, for example, a situation and the like of the own vehicle 1 at that point of time. More specifically, for example, in a case where a preceding vehicle is present immediately in front of the own vehicle 1, it may be difficult to check the shape of the road ahead, and it may be impossible to recognize a position of the course change starting point 103 until just before the course change starting point 103 appears. However, variably setting the dynamic display state enables handling such as displaying a route in a highlighted manner, thereby enhancing safety.

In addition to the above, for example, in the first setting processing, it is possible to perform control display of a superimposed image according to an actual travel environment by variably setting a display parameter according to travel environment information acquired by the information acquisition processing S1 (see FIG. 3). The appropriate rate of change of a display content in the dynamic display state is related to a change in an actual environment. For example, when a rate of change of the virtual image V decreases in a case where animation display in the dynamic display state is performed while the own vehicle is traveling at a high speed, since the rate of change of the virtual image V decreases despite that a change in actual scenery is large. This may cause a large difference, and the driver 5 may find it difficult to associate the displayed superimposed image with a change in the actual scenery viewed from the own vehicle 1 that is actually traveling. To handle a situation as described above, a method of shortening a time required for a dynamic display state per time is conceived. A specific example of a method of changing is illustrated in FIG. 10. FIG. 10 illustrates a time of a dynamic display state with respect to a speed of the own vehicle 1, and illustrates a case where the time is changed linearly, nonlinearly, or stepwise with respect to a speed of the own vehicle 1.

Further, in a case where the vehicle speed changes abruptly during a dynamic display state due to sudden braking, emergency avoidance or the like, the rate of change of the dynamic display state may be changed in real time according to a change in vehicle speed. Furthermore, for example, a time of a dynamic display state in FIG. 10 associated with a vehicle speed v1 may be set at a predetermined timing, and when the vehicle speed changes to v2, the time of the dynamic display state may be set short accordingly, and in a case where the vehicle speed returns to v1 again, the time of the dynamic display state may be set back to the previous value.

Furthermore, in a case where the vehicle speed reaches zero, and the own vehicle 1 stops in a state before display of the virtual image V does not reach display of a final still image (e.g., a case where the own vehicle encounters a traffic jam near an exit of an expressway, a case where the own vehicle waits at a traffic light at an intersection, a case where the own vehicle stops for traffic control, or the like), the virtual image V is displayed in a halfway state for a long period of time, and therefore, the driver 5 may feel a sense of discomfort. In such a case, it is desirable to perform processing of reducing a luminance of the virtual image V after a predetermined stopping time has elapsed. Then, in a case where the own vehicle starts moving again, processing of restoring the luminance of the virtual image V is performed. This enables to reduce annoyance to the driver 5 without displaying, to the driver 5, information that is not necessary when the own vehicle 1 is stopping.

In this way, a time required for determination by the driver 5, a time required for avoiding a danger, a vehicle control mode, and the like may differ in various ways depending on a speed, a position, or the like of the own vehicle 1. However, variably setting a display parameter according to travel environment information enables to achieve optimum settings depending on the above, and enables to secure safety and comfort of the driver 5.

In addition, setting a luminance of the virtual image V high during a time of a dynamic display state, as compared with a time of a static display state enables to improve attractiveness to the driver 5.

Note that, in the present embodiment, control relating to navigation display has been mainly described, but the present technique can also be applied, in addition to the above, for example, to display control of information to be displayed on a meter panel, information relating to an operation of an in-car facility such as an air conditioner and stereo equipment, information on a surrounding environment, information relating to sightseeing, information relating to shopping, and the like.

### REFERENCE SIGNS LIST

L Display light
V Virtual image (superimposed image)
1 Vehicle (own vehicle)
2 Dashboard
3 Windshield (display area)
4 Eye box
5 Driver (viewer)
10 HUD device
20 Display unit
30 Control device
31 Control unit
31a CPU
31b GDC
32 ROM
33 RAM
40 Peripheral information acquisition unit
50 Forward information acquisition unit
60 Car navigation device
70 ECU
80 Operation unit
100 Vehicle display system
101 Display starting point
102 Display switching point
103 Course change starting point

1. A head-up display device that displays a superimposed image in such a way as to be viewed by a viewer, as a virtual image overlapping a scenery in front of an own vehicle in a display area in front of the own vehicle, comprising:
a control unit that performs display control of the superimposed image, wherein
the control unit performs
information acquisition processing of acquiring travel environment information pertaining to a travel environment of the own vehicle,
determination processing of determining whether the travel environment information acquired by the information acquisition processing satisfies a predetermined condition, and
animation processing of displaying the superimposed image by animation in which a plurality of still images are successively switched without a light being turned off, in a case where it is determined that the predetermined condition is satisfied by the determination processing, and
in the animation processing,
display switching is performed in which switching is performed from a static display state of one of the still images to a static display state of a next one of the still images in a sequence via a dynamic display state in which switching is performed through dynamic change from one of the still images to the next still image in the sequence, and motion that intermittently changes is expressed.

2. The head-up display device according to claim 1, wherein
in the animation processing, the control unit performs the display switching at least twice.

3. The head-up display device according to claim 2, wherein
the superimposed image is an image in which the virtual image is displayed in navigation in such a way as to guide a travel route of the own vehicle, and
the control unit
in the information acquisition processing, acquires a travel position of the own vehicle, as the travel environment information, in the determination processing, determines, as the predetermined condition, whether the own vehicle reaches within a predetermined distance to a predetermined navigation target point, and in the animation processing, displays the still image including a lane boundary line in the static display state, and dynamically changes a length or a shape of the lane boundary line in the dynamic display state.

4. The head-up display device according to claim 3, wherein, in the animation processing, the control unit newly adds and displays control promotion display of promoting vehicle control associated with an event that the own vehicle reaches the navigation target point in the dynamic display state immediately before switching is performed to the last still image in a sequence.

5. The head-up display device according to claim 3, wherein the control unit further performs first setting processing of variably setting a display parameter pertaining to the dynamic display state and the static display state in the animation processing.

6. The head-up display device according to claim 5, wherein in the first setting processing, the control unit variably sets, as the display parameter, at least one of a start timing of the animation processing, the number of times of the display switching, and a duration of time of the dynamic display state.

7. The head-up display device according to claim 5, wherein
in the first setting processing, the control unit variably sets the display parameter according to the travel environment information acquired by the information acquisition processing.

8. The head-up display device according to claim 3, wherein
the control unit further performs second setting processing of variably setting a dynamic switching mode in the dynamic display state of the animation processing.

9. The head-up display device according to claim 8, wherein
in the second setting processing, the control unit displays, as the dynamic switching mode, the travel route or the lane boundary line in a highlighted manner.

10. The head-up display device according to claim 1, wherein
the control unit performs display control of the superimposed image in such a way that the virtual image is displayed as a first image to be viewed along a road surface in front of the own vehicle in the display area, or a second image to be viewed in such a way that the second image rises toward the viewer's side than the first image.
